(19) United States
(12) Patent Application Publication
(10) Pub. No.: US 2026/0205685 A1
(43) Pub. Date: Jul. 16, 2026

(54) REMOTE MONITORING SYSTEM WITH POWER USE OPTIMIZATION

(71) Applicant: Spot AI, Inc., Lehi, UT (US)

(72) Inventors: Ryan Young, San Francisco, CA (US); Subramanian Ganapathy, Pleasanton, CA (US); Telind Jackson Bench, Oakland, CA (US); Ava O'Neill, Lehi, UT (US); Stephen Samuel Segal, Aventura, FL (US); Nathan Andrew Harmon, Roseville, CA (US); Paul Hugh Carrigg, Portland, OR (US); Pete Nicholas Chulick, San Francisco, CA (US); Nathaniel Paul Lee, San Francisco, CA (US); Gurunathan Govindan, Redmond, WA (US); Kevin Tajeran, Roseville, CA (US)

(21) Appl. No.: 19/018,704

(22) Filed: Jan. 13, 2025

(51) Int. Cl. G08B 13/196

(52) U.S. Cl. CPC G08B 13/19604; G08B 13/19617; G08B 13/19636; G08B 13/19643; G08B 13/19656; G08B 13/19691

(57) ABSTRACT

A remote monitoring system optimizes power use while maintaining surveillance capabilities. The system includes a camera, infrared light, rechargeable battery, solar panel, and computing device. The method involves capturing digital images at night with the infrared light off, enhancing image quality using denoising, and determining event occurrence based on triggers. Upon event detection, the system powers on the infrared light to capture additional images. The system can perform actions such as sending notifications or activating alarms. The modular design allows flexible installation, making the system suitable for remote areas with limited infrastructure.

### TECHNICAL FIELD

The subject matter disclosed herein generally relates to methods, systems, and machine-readable storage media for an autonomous monitoring system with power consumption management.

### BACKGROUND

Remote areas often face significant challenges in maintaining effective security monitoring. The lack of reliable power sources and network connectivity complicates the deployment of traditional security systems. These areas frequently experience specific types of events, such as unauthorized access or criminal activities, which require timely detection and response. Conventional security solutions often rely on continuous power and network connections, making them unsuitable for remote locations.

Existing solutions for remote monitoring typically involve complex installations with high power consumption. These systems often depend on infrared illumination for nighttime visibility, leading to increased energy usage. The reliance on traditional power sources and network infrastructure results in higher operational costs and reduced flexibility in system placement.

### BRIEF DESCRIPTION OF THE DRAWINGS

Various appended drawings illustrate examples of the present disclosure and cannot be considered limiting its scope.

FIG. 1 is a user interface (UI) for reviewing events in a video surveillance system, according to some examples.

FIG. 2 shows a Remote Monitoring System (RMS), according to some examples.

FIG. 3 is a sample high-level architecture for event detection, according to some examples.

FIG. 4 is a UI for creating events, according to some examples.

FIG. 5 is a UI illustrating the operations for creating a new event based on a template, according to some examples.

FIG. 6 illustrates the structure of an event for fence-jumping detection, according to some examples.

FIG. 7 shows the UI with options for selection actions to perform in response to detecting an event, according to some examples.

FIG. 8 is a chart showing power consumption when using an infrared Light-Emitting Diode (LED), according to some examples.

FIG. 9 shows the processing of images with and without denoising, according to some examples.

FIG. 10 is a flowchart of a method for reducing power consumption using denoising of a digital image, according to some examples.

FIG. 11 includes charts showing the power consumption when using the infrared LED, according to some examples.

FIG. 12 is a flowchart of a method for nighttime event detection with intermittent image capture and the use of the infrared LED, according to some examples.

FIG. 13 is a chart showing event detection using a thermal camera, according to some examples.

FIG. 14 is a flowchart of a method for event detection using digital and thermal cameras, according to some examples.

FIG. 15 is a flowchart of a method for event detection using digital images and RAdio Detection And Ranging (RADAR), according to some examples.

FIG. 16 illustrates a cloud environment for implementing examples.

FIG. 17 is a flowchart of a method for power management in a remote security monitoring system, according to some examples.

FIG. 18 is a block diagram illustrating an example of a machine upon or by which one or more example process examples described herein may be implemented or controlled.

### DETAILED DESCRIPTION

Example methods, systems, and computer programs are directed at power management in a remote monitoring system. Examples merely typify possible variations. Unless explicitly stated otherwise, components and functions are optional and may be combined or subdivided, and operations may vary in sequence or be combined or subdivided. The following description provides numerous specific details to provide a thorough understanding of examples. However, it will be evident to one skilled in the art that the present subject matter may be practiced without these specific details.

The disclosed system addresses these challenges by providing a self-sufficient remote monitoring unit that operates without the need for external power or network connections. The solution described involves a remote monitoring system designed to optimize power consumption while maintaining effective surveillance capabilities. One system includes a camera, an infrared light, a rechargeable battery, a solar panel, and a computing device. One method includes capturing digital images at nighttime while an infrared light is powered off. This approach conserves energy by enhancing image quality utilizing denoising (e.g., AI-based denoising, signal processing), reducing the need for infrared illumination.

The system determines whether a trigger or combination of triggers has been activated based on the enhanced digital image. Upon detecting an event, the infrared light is powered on to capture additional images, ensuring comprehensive documentation. The system can automatically perform actions in response to the event, such as sending notifications or activating alarms.

A benefit of this solution is its ability to operate independently of traditional power sources, reducing operational costs and increasing deployment flexibility. The use of AI denoising allows for effective event detection without constant infrared illumination, further optimizing power usage.

The system also supports additional features, such as radar or lidar for extended monitoring range and thermal cameras for nighttime detection. These components enhance the system's ability to monitor remote areas with limited infrastructure. The modular design allows for flexible installation on poles, walls, or trailers, making the system adaptable to various environments.

Overall, the solution provides a self-sufficient approach to remote surveillance, leveraging advanced technologies to maintain effective monitoring while optimizing power consumption. This addresses the challenges of deploying security systems in areas with limited infrastructure, offering a versatile and efficient monitoring solution.

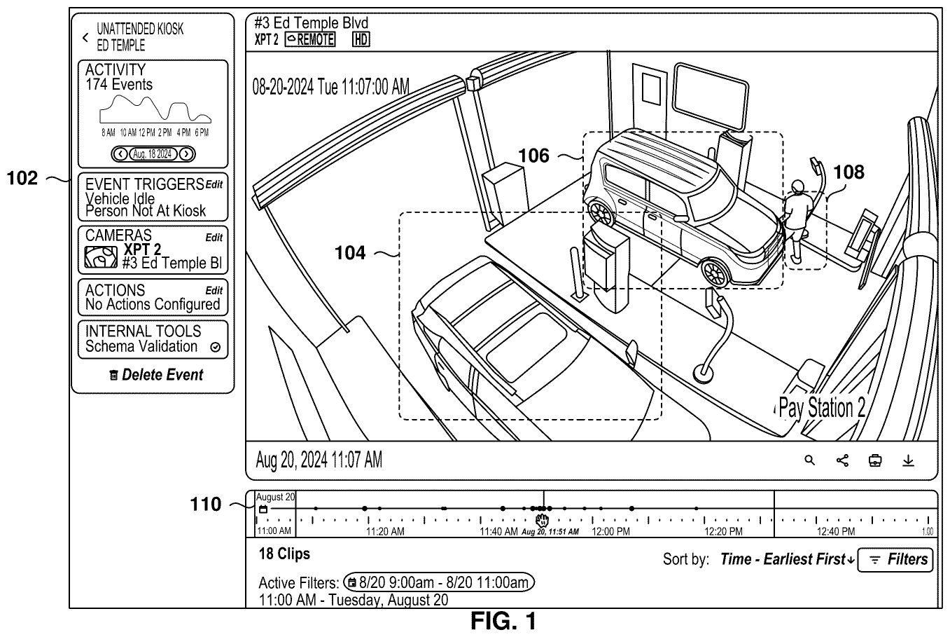

FIG. 1 is a user interface (UI 102) for reviewing events in a video surveillance system, according to some examples. The UI 102 provides a comprehensive view of an event in an area being monitored. An event is a specific occurrence of a predefined situation detected by the video surveillance system. For example, the event occurrence may be identified using heuristics or AI models and may involve the detection of object presence, object absence, object interactions, or relationships between objects. The occurrence of the event is detected based on a trigger or a combination of triggers.

The UI 102 interface displays an image of a live video feed from a security camera capturing the area around the kiosk, highlighting specific elements such as vehicle 104 and vehicle 106. These vehicles are identified within designated zones (e.g., rectangles that are bounding boxes) that have been identified by a machine-learning (ML) model.

Person 108 is also detected within the scene, interacting with the kiosk environment. The system uses advanced AI models to track and identify objects, ensuring accurate monitoring of the area. The interface includes a timeline 110 at the bottom, which allows users to navigate through recorded events. This timeline provides a visual representation of the events captured, enabling efficient review and analysis of the footage. Users can view timestamps and select specific clips for review, with options to sort and filter the clips based on time and other criteria.

An information panel, located on the left side of the UI 102, displays details about the surveillance activity. It includes sections for “Activity” (showing the number of events), “Event Triggers” (listing specific triggers such as “Vehicle Idle” and “Person Not Attending Kiosk”), and “Cameras” (indicating the active camera feed). Options for editing these settings are available.

There is a need to identify events, such as when a vehicle approaches too closely to a person or a customer has been waiting for more than 30 seconds without staff attending. In existing solutions, identifying specific instances in video footage requires manually reviewing the entire footage sequence. The proposed solution simplifies the process by performing intelligent filtering of events in order to reduce the number of situations that need attention. The system is designed to analyze historical data about events quickly and using flexible selection parameters.

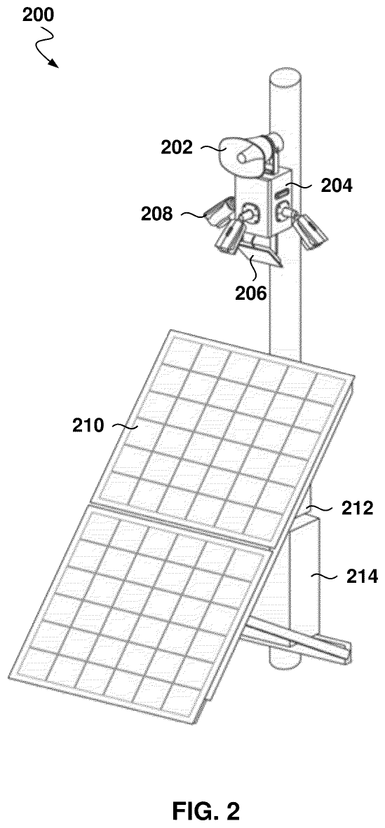

FIG. 2 shows a Remote Monitoring System (RMS 200), according to some examples. Remote areas are difficult to monitor for several reasons, such as the lack of utility power and lack of personnel on the site. Companies want to deter criminal behavior in these remote areas proactively. To address this problem, the RMS 200 is an autonomous system that provides a monitoring solution for these remote areas.

The RMS 200 includes a speaker 202, a head unit 204, a floodlight 206, one or more cameras 208, a solar panel 210, an Intelligent Video Recorder (IVR 212), and a rechargeable battery 214.

In some examples, the RMS 200 does not have a connection to a power outlet, so the RMS 200 relies on the rechargeable battery 214 for power.

The head unit 204 serves as the central processing hub, integrating various components for seamless operation. The speaker may be used to make announcements or deliver messages to people near the RMS 200, such as warnings to intruders asking to leave the area.

The floodlight 206 enhances visibility during low-light conditions, ensuring that the cameras can capture clear images even at night. In some examples, the floodlights are not active during normal operation, but the floodlight 206 is turned on when an event is detected, e.g., someone entering a predefined area, someone jumping over a fence, etc.

The one or more cameras 208 are positioned to provide comprehensive surveillance coverage. These cameras are capable of capturing high-resolution images and videos used for monitoring and security purposes. The floodlight 206 enhances visibility during low-light conditions, ensuring that the cameras can capture clear images even at night. In some examples, the one or more cameras include an infrared light that may be used at night to enhance the image quality.

The solar panel 210 is included to provide a renewable energy source, enabling the system to operate independently of external power supplies. This solar panel charges the rechargeable battery 214, which stores energy for use during periods without sunlight, ensuring continuous operation.

The Intelligent Video Recorder (IVR 212) is integrated into the system to record and process video data and manage storage. This component allows for efficient data handling and retrieval, supporting advanced features such as AI-based image processing and event detection. In some examples, the IVR 212 does not have network communications, but some configurations include wireless network interfaces, such as mobile telephony or satellite modems, to communicate with the central monitoring server.

The rechargeable battery 214 maintains system functionality during nighttime or cloudy conditions. This rechargeable battery 214 works in conjunction with the solar panel 210 to provide a reliable power source in locations where a power outlet is not available.

The RMS 200 is self-sufficient because it does not require utility power or a network connection, although the network connection may also be provided.

The use of AI agents at the IVR 212 provides functionality to facilitate the monitoring of specific events of interest, such as fence jumping, that are likely to occur at locations on the periphery of a facility. The IVR 212 is able to detect fence jumping, and the AI agents will perform predefined actions in response to the detection.

The RMS 200 includes active deterrence features, such as using a bullhorn to sound an alarm and turn on the floodlight 206. The AI agents can detect the risk events and subsequently activate the active deterrence features. These features may include a siren or a pre-recorded audio message that informs the trespasser about the detected action and advises immediate departure.

Although the illustrated examples show a pole mount configuration, other configurations are also possible, such as installations on top trailers, train stations, grocery and other retail stores, construction sites, etc. The modular design of the RMS 200 also allows for installation on a wall.

Since the RMS 200 is powered by rechargeable batteries, power consumption is important to avoid having interruption in coverage if the RMS 200 runs out of power, e.g., at night. Solutions are presented to manage power consumption.

Reducing power consumption has benefits, such as the possibility of using a smaller battery and a smaller solar array, which results in reduced weight and a smaller cross-sectional area. Weight and cross-sectional area are important issues for some users because the RMS 200 is mounted on top of a pole. Mounting components on poles can reduce stability, and increase the risk of toppling during seismic activity (due to the device weight) or high winds (due to large surfaces acting as sails in the wind). The structural integrity of the pole is another factor; poles may have varying diameters, typically ranging from approximately two to four inches to as much as six to eight inches. An increase in the diameter of a pole correlates with an increase in rigidity but also cost.

Although some components could be mounted at the bottom of the pole to improve stability, most users prefer not to have the system in easy reach of potential intruders that could sabotage the RMS 200.

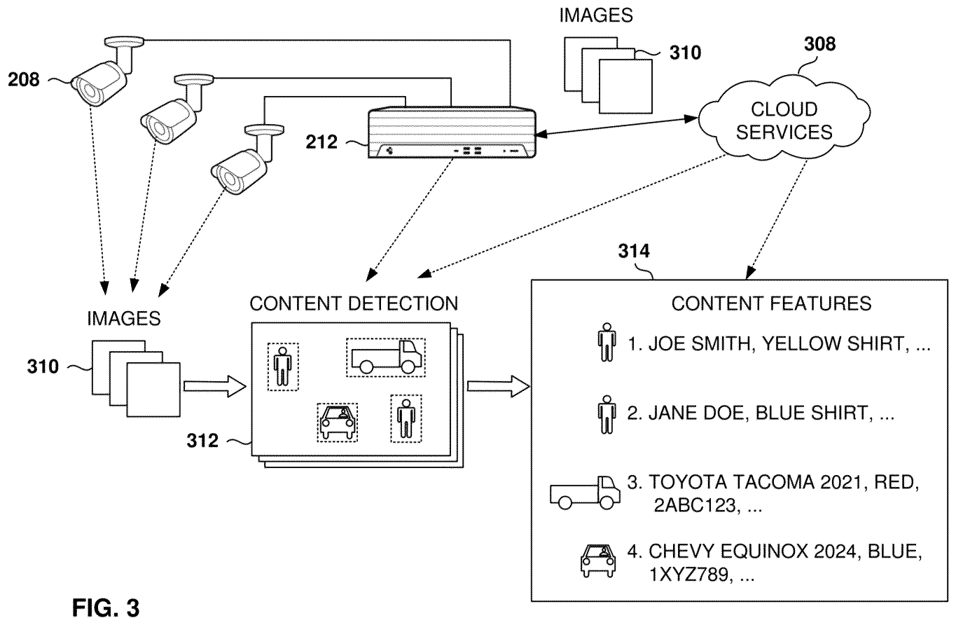

FIG. 3 is a sample high-level architecture for event detection, according to some examples. The system comprises several components that work together to analyze video data and detect events.

One or more cameras 208 capture video data and transmit the video data to the IVR 212. In some examples, the IVR 212 processes the video data and sends the video data to cloud services 308 for further analysis. The cloud services 308 provides additional computational resources and storage capabilities, enabling advanced processing and data management.

In some examples, the IVR 212 does not include network connectivity, so the information is not sent to the cloud services 308. The IVR 212 is able to work autonomously to detect events and execute the associated actions.

The IVR 212 is a high-performance, AI-powered video recording system designed to enhance video surveillance and security operations. The IVR 212 offers a hybrid architecture that combines local storage with cloud-based features, enabling users to securely store video locally while backing up event-related footage to the cloud. This setup ensures video data is both easily accessible and protected, with encryption measures in place to secure it during both storage and transmission.

The IVR 212 is compatible with any Internet Protocol (IP) camera, allowing users to integrate their existing camera setups. In some examples, the IVR 212 can scale to accommodate a wide range of camera counts, supporting configurations from small installations of 8 cameras to larger enterprise deployments of up to 64 cameras. This flexibility is further enhanced by advanced AI-driven features such as people counting, vehicle tracking, and the ability to search footage quickly using intuitive filters.

The IVR 212 also offers robust redundancy features, including Redundant Array of Independent Disks (RAID) support in larger systems. Additionally, the system ensures that users can automate workflows, improve operations, and access footage easily from a centralized cloud dashboard.

Images 310 represent the video frames extracted from the video data. These frames are subjected to content detection 312 by the agents executing in the IVR 212, where objects and features within the frames are identified (e.g., bounding boxes defined around each object to identify the location, as well as metadata describing characteristics of the object). It is understood that object is used as a generic term and may also include people. In some examples, the content detection 312 utilizes machine learning models to recognize and classify objects such as people and vehicles. The content may be analyzed by the IVR 212 or by the cloud services 308.

Content features 314 are generated from the detected objects and saved as metadata associated with each object. These features may include attributes such as identity, clothing color, vehicle make and model, and license plate information. The content features 314 are analyzed for the detection of events based on predefined conditions and relationships between the detected objects.

The integration of these components allows for efficient event detection and monitoring, providing users with the ability to define and respond to specific scenarios. The system leverages both edge and cloud computing to optimize performance and scalability.

Video is defined as a list of streams or as a list of frames, also referred to as images 310, that are continuously transmitted from the camera. The purpose is to maintain an uninterrupted recording of video content, which is then stored and utilized for various applications.

One objective is to identify the presence of individuals, vehicles, forklifts, weapons, etc., within the frame and record the positions of these specified objects. The agent uses an AI model to detect these objects.

Bounding boxes are drawn around the objects to indicate their locations. At a certain point, these objects may move. To detect movement, the positions of these objects are periodically checked, e.g., one to three times per second.

For example, an individual relocates to another area, and a forklift changes its position when moving away. Subsequently, these objects may temporarily become unobservable. The system is tasked with redetecting these objects to ascertain their new locations. The video processing pipeline checks to re-identify these objects in order to maintain a consistent recognition of objects and their movement, which includes evaluating the velocity and new positions of the detected objects.

Once a single-or multi-pass heuristic has determined the presence of an individual, a detection of the person's features is performed. For example, these features may include, but are not limited to, the color of the shirt, the color of the pants, a person's identity (e.g., via facial recognition), etc. These identified features are then stored to facilitate the search of specific events (e.g., finding when a particular person entered one zone).

The system converts the information into an enumeration of individuals, vehicles, forklifts, fences, etc., present within the frame. For example, object number one has been identified as person number one, and the individual is detected wearing a yellow shirt and blue pants. A detection list is compiled from these observations.

The presence of a second individual, various objects, a third individual, and various vehicles may occur. The attributes of a vehicle may include make, model, and license plate (e.g., detected via license plate reading).

In some examples, the IVR 212 sends the identified object data to the cloud services 308 for further processing. This data can pertain to a wide array of metrics such as temperature, humidity, energy consumption, air quality, and more.

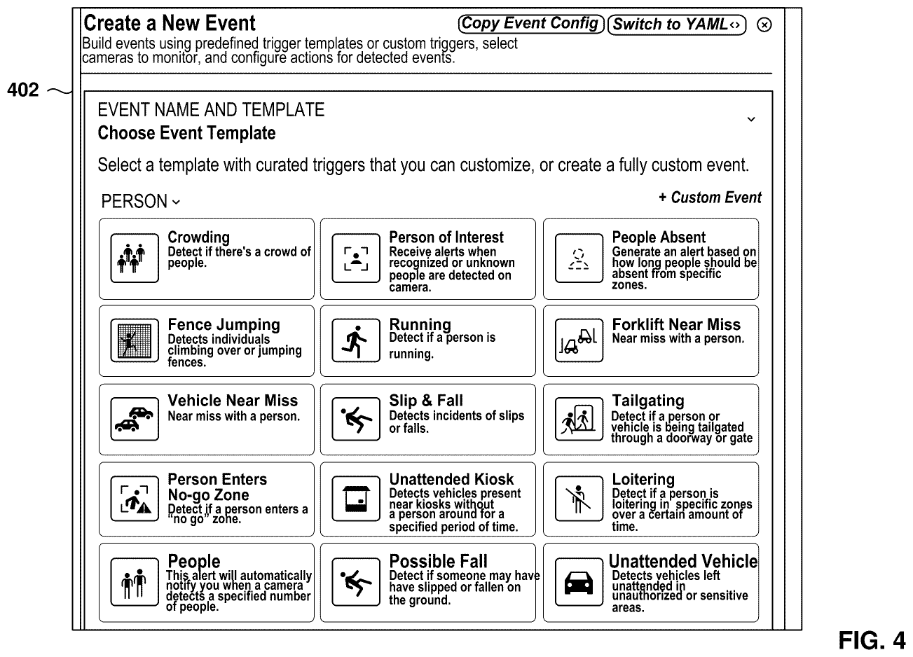

FIG. 4 is a UI 402 for creating agents, according to some examples. An event template is a pre-configured agent for detecting the occurrence of a specific type of event. The event template comprises one or more triggers and one or more actions.

The UI 402 includes a section labeled “Event Name and Template,” where users can choose an event template. Various templates are displayed, each represented by an icon and a brief description. These templates include options such as “Crowding,” “Person of Interest,” “People Absent,” “Fence Jumping,” “Running,” “Forklift Near Miss,” “Vehicle Near Miss,” “Slip & Fall,” “Tailgating,” “Person Enters No-go Zones,” “Unattended Kiosk,” “Loitering,” “People,” “Possible Fall,” and “Unattended Vehicle.” Each template is designed to detect specific events or conditions, allowing users to customize alerts and actions based on the selected triggers.

For example, the People-Absent event template detects scenarios where individuals are expected to be present but are not detected within a defined area for a specified period. It uses object detection to monitor absence in designated zones.

The event for Forklift Near Miss identifies situations where a forklift comes dangerously close to other objects or people, potentially causing an accident. It analyzes proximity and movement patterns to detect near-miss incidents.

The event for Unattended Kiosk monitors kiosks to detect when they are left unattended. It tracks the presence of personnel in proximity to the kiosk and triggers alerts if no one is detected for a predetermined threshold duration.

For Fence Jumping, the event template detects instances where individuals attempt to climb or jump over a fence. It monitors specific zones for unauthorized entry and triggers alerts when such activity is detected.

For Slip and Fall, the template identifies occurrences where a person slips or falls within a monitored area. It analyzes body movements and positions to detect potential accidents and issues alerts for immediate response.

For Tailgating, the template detects situations where an unauthorized person or vehicle follows closely behind an authorized individual or vehicle to gain access to a restricted area. It monitors entry points and analyzes the sequence of entries to identify tailgating incidents.

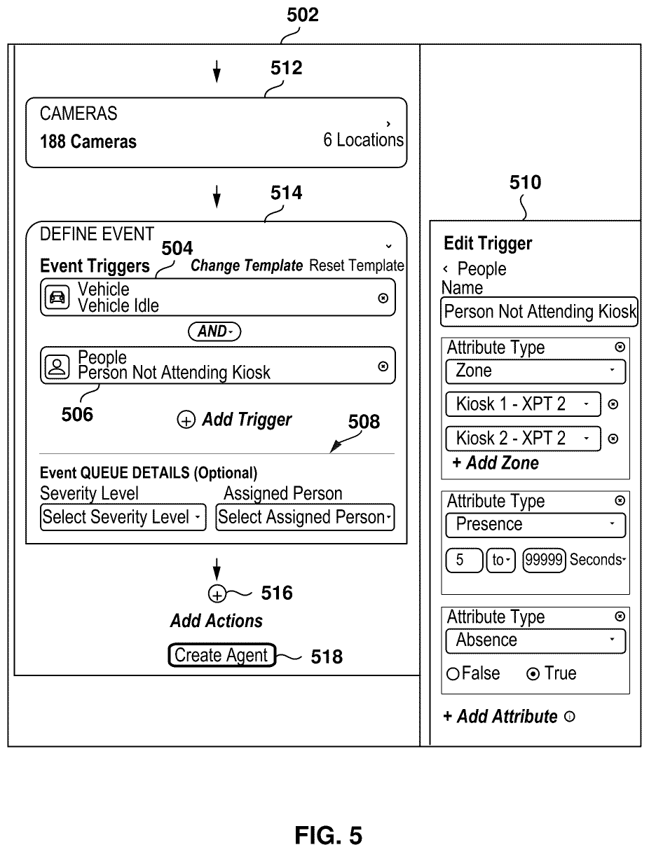

FIG. 5 is a UI 502 illustrating the operations for creating a new event based on a template, according to some examples. The UI 502 is designed to facilitate the configuration of an agent for event detection within a video surveillance system.

To create agents, the system allows the use of any data available in the platform and the possibility of combining different data to create alerts for custom events tailored to each organization's use case. For example, when a school administrator wants to prevent trespassing, the administrator wants to be alerted when someone is jumping a fence so that they can dispatch a police officer or faculty to address the trespassing event immediately. In another example, when a manager is attempting to reduce safety accidents, the manager wants to know if an accident is about to happen, such as a near miss or a fall, so that they can train and change processes to reduce the number of accidents and reduce costs for the company.

The platform provides a security copilot, which is a personalized assistant working with the user to safeguard the spaces important to the user. The user can create their own agents from scratch or use one of the predefined templates. The agent of the security copilot automatically identifies safety and security events and responds to these events.

The initial operation for creating an agent is the selection of cameras in the “Cameras” section 512 to allow users to identify cameras for monitoring. This section includes a dropdown menu where users can choose specific cameras or select all available cameras for the event. The illustrated example shows the number of cameras (188 Cameras) and their distribution across locations (6 Locations).

After selecting cameras, the “Define Event” section 514 is for specifying the conditions and triggers for the agent. This operation involves setting parameters such as object presence, absence, and specific object relationships, which are used for accurate event detection.

The “Define Event” section 514 allows users to specify event triggers in a field where users can select predefined conditions. The example shown includes a trigger 504 for “Vehicle Idle.” The trigger may comprise one or more conditions. In the illustrated examples, there is a second trigger 506 (e.g., “Person Not Attending Kiosk”), and the triggers are logically combined using the logical operator AND. The user has the option to change to the OR logical operator or some other logical function. Users can add more triggers by selecting the “Add Trigger” option.

The “Event Queue Details” section 508 provides optional fields for further customization. Users can select a “Severity Level” and assign a person responsible for the event by using dropdown menus labeled “Select Severity Level” and “Select Assigned Person.” In some examples, the severity levels include high, medium, and low, but other examples may use other severity categories. If the user selects the option to assign a person, a drop-down menu presents people who may be assigned the notification of the event.

The “Edit Trigger” panel 510 allows for detailed configuration of the selected triggers. Users can name the trigger and define various attribute types, such as “Zone” and “Presence.” The example shows settings for zones (e.g., “Kiosk 1-XPT 2”) and presence duration (e.g., “5 to 9999 seconds”). Additional attributes like “Absence” can be set to true or false, and users can add more attributes as needed.

The interface is designed to facilitate the creation and management of complex triggers, providing users with a comprehensive set of tools for system monitoring and response.

Another event template is for detecting a near miss between a person and a forklift. In this case, the object relationship is defined as overlapping; that is, the location of the person and the location of the forklift overlap in the image, indicating that there has been contact or close to being in contact.

In some examples, the relationship condition includes three options:
“Is Overlapping” (location of the bounding boxes of the objects intersect), “Position Relationship” (relative position), and “Overlap Distance” (to configure distance between the objects). The Position Relationship defines a directional relationship of one object with reference to the other object. For example, for a car and a person, the Position relationship may be defined as above, below, left, and right, but other examples may include additional options. For example, a person under a vehicle may be used to detect possible situations for the theft of catalytic converters.

The agent would detect the two objects, e.g., person and forklift or some other object, and the creation of the object-relationship condition of overlapping. Further, another condition is set for the second object, the forklift, to be moving. This way, if the forklift is not moving, the event will not trigger just because the person is walking by the forklift.

Some of the available triggers related to people include absence (no people detected), count (number of people in the frame), duration (amount of time a person is within the surveilled area), speed (at which the person is moving), angle direction (defining the orientation of the person), idle time (amount of time the person has not moved), is moving (the person is on the move), presence (the person is present in the frame), screen size (amount of space in the frame that the person is occupied), zoom (person is present in a predefined zone), semantic search (enables to search for metadata parameters associated with the person), after clothing color, lower clothing color, pose angle, etc.

For example, the pose angle may be used to determine that a person has fallen. The absence trigger is useful to determine when there is no person in the image, which assists in identifying conditions such as when a kiosk is unattended when a car arrives, and nobody attends the customer for a minimum configured amount of time.

Each trigger may include respective options. For example, the presence trigger may include fields to configure a range of time, the fields being “From” and “To,” so the user can configure the presence of an object from 10 to 60 seconds. This may be used to indicate that a vehicle has been idle for at least ten seconds.

In the illustrated example, a first attribute type is for a zone, which is defined as the combination of two zones corresponding to two kiosks. Further, the presence condition may be configured to trigger the event after a certain amount of time happens before the vehicle is idling without a person responding.

The objects may be defined either by a user or by the entity conducting the analysis. Users are able to delineate certain zones or specific areas within a camera view that represent an area of interest. For example, the area for the kiosk could be delineated, identifying it as the kiosk or as the lane designated for vehicle operations or a similar context. The zones may be defined by the user or identified automatically by the system, such as detecting a zone in front of a gas pump.

The interaction of the objects is based on where the objects are in relation to each other. In some examples, the relationship is based on the relationship between the center of the detected boxes for each object.

The “Add Actions” button 516 enables users to configure actions that the agent will perform upon detecting the event. These actions may include sending notifications, triggering alarms, or executing other automated responses through integrated systems. The “Create Event” button 518 finalizes the agent creation process, saving the defined parameters and actions.

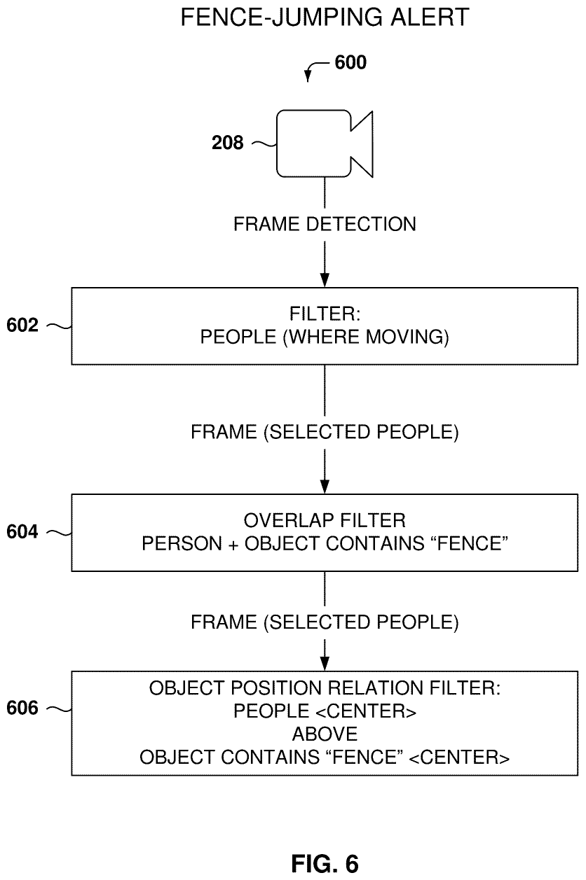

FIG. 6 illustrates the structure of an agent 600 for fence-jumping detection, according to some examples. A camera 208 captures video frames in real-time of an area with a fence where fence-jumping might occur.

After frame detection, at operation 602, the agent identifies frames containing moving people. This is achieved through a filter that detects movement based on several frames.

Operation 604 is to apply an overlap filter that checks for spatial overlap between a person and an object identified as a fence (e.g., the fence has been defined as a zone within the monitored area). The overlap filter uses geometric analysis to determine if a person and a fence occupy the same or adjacent space within a frame.

At operation 606, an object position relation filter is applied to analyze the positional relationship between the person and the fence.

Specifically, the filter checks if the center of the person is above the center of the fence. This positional analysis helps confirm that a fence-jumping event is occurring, allowing the system to trigger appropriate alerts or actions.

It is noted that “above” is one of the options provided in the UI for comparing the positions of two objects. For example, the above option may be used when a person is “above” a fence during fence jumping. Other options include below, to the right, to the left, to one side, etc.

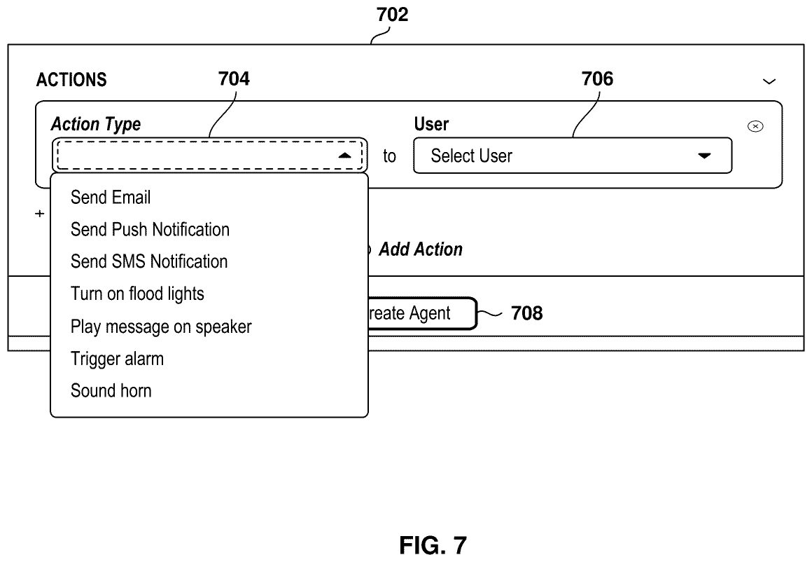

FIG. 7 shows the UI 702 with options for selection actions to perform in response to detecting an event, according to some examples. The action type field 704 is a dropdown menu that allows the user to select the type of action to be performed when an event is triggered. In some examples, the options available in this dropdown include “Send Email,” “Send push notification,” “Send SMS notification,” “Send daily summary email,” “Turn on flood lights,” “Play message on speaker,” “Trigger alarm,” and “Sound horn,” but other implementations may utilize different or additional actions, such as making a phone call, sending a voice text, etc.

These actions may discourage individuals from engaging in criminal activities, such as parking lots of dealers or rental companies. Another type of action would be to call a security company or the police when criminal activity is suspected.

Alternative actions may involve utilizing an Application Programming Interface (API) to initiate other types of actions. Integration is possible, for instance, with access control systems (e.g., badging systems). An API may be used to perform actions on real-life machines, such as locking or unlocking doors. It is possible to specify, for example, that when an unrecognized individual is detected, all doors should be locked, alarms should be activated, and lights should be turned on.

The user selection field 706 is a dropdown menu that enables the user to select a specific user to whom the action will be directed. The field is labeled “User” and provides a list of users from which to choose.

Once the actions and user are configured, the button Create Agent 708 may be selected to create the agent after the configuration is complete.

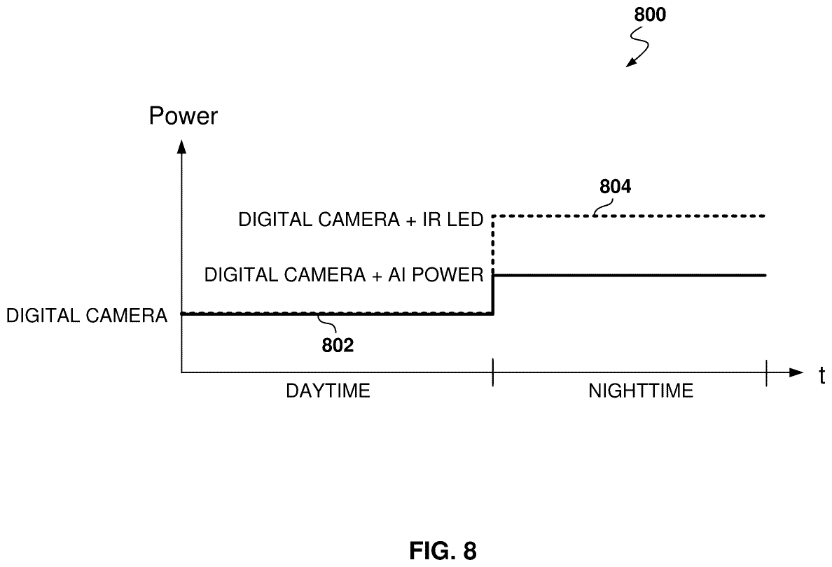

FIG. 8 is a chart 800 showing power consumption when using an infrared Light-Emitting Diode (LED), according to some examples. The camera consumes a certain amount of power during daylight hours. Daylight conditions represent the best-case operation due to the presence of sunlight that charges the battery and provides the best conditions for recording video.

Challenges arise during nighttime operations as the absence of significant light reduces visibility, affecting the camera's ability to capture images accurately.

Typically, the infrared function of the camera remains deactivated during daytime due to adequate ambient light levels. When ambient conditions become insufficient for illumination, the infrared light is turned on. Also, the infrared light may be turned on to be able to provide color images. However, the infrared functionality contributes significantly to overall power consumption.

The challenge is how to detect objects in images that have a low signal-to-noise ratio in conditions with insufficient light, particularly during nighttime. Attempting to enhance a dim image post-capture through software may result in pronounced graininess or noise due to the poor quality of the original image.

A solution to reduce the device's total power usage involves minimizing the usage of infrared light to reduce power demands. One method includes the use of denoising to improve the quality of images taken at night. One solution for denoising utilizes artificial intelligence and is termed AI Denoise.

Denoising a digital image is the process of removing noise or unwanted random variations from the image while preserving details like edges and textures. Denoising is useful for improving the quality of images captured under low-light conditions or with sensor limitations.

Image noise refers to unwanted disturbances that degrade the image's quality. Common types of noise include Gaussian noise (random noise with a normal distribution, often caused by electronic interference), salt-and-pepper noise (random bright and dark spots in the image), Poisson noise (occurs due to the variation in the number of photons sensed by the camera's sensor), and speckle noise.

Several techniques and algorithms can be used to denoise an image. The choice depends on the type of noise and the desired quality of the output. Some of these techniques include: averaging filter (replaces each pixel's value with the average value of neighboring pixels, reducing noise but also blurring the image), Gaussian blur (uses a Gaussian function to give more weight to the central pixels), median filter (replaces each pixel with the median value from the surrounding neighborhood, effective at removing salt-and-pepper noise without blurring edges), bilateral filter (filter that preserves edges while reducing noise by considering both spatial distance and intensity difference), non-local means (reduces noise by averaging similar image patches from the entire image, preserving fine details), and wavelet denoising (applies wavelet transformations to separate noise from the image by working in the frequency domain).

Another technique for denoising involves the use of AI to improve the image quality. AI denoising refers to the process of using artificial intelligence, specifically deep learning techniques, to remove noise from digital images. Unlike traditional methods that rely on predefined filters or mathematical models, AI-based denoising techniques learn from vast datasets to make intelligent predictions about which parts of an image are noise and which parts are important features, such as edges, textures, and details.

AI-based denoising typically uses deep learning models, such as convolutional neural networks (CNNs), that are trained on large datasets of noisy and clean images. The model learns to distinguish between noise and image content by minimizing the difference between its denoised output and the corresponding clean image during training.

In supervised learning, the AI model is trained using paired data: one noisy image and its corresponding noise-free version (ground truth). Through repeated exposure to these pairs, the model learns to predict what a clean image should look like. In some examples, the difference between the denoised output of the model and the true clean image is measured using a loss function, like mean squared error (MSE). The model adjusts its internal parameters to minimize this loss.

The architecture of AI Models for Denoising may include the following:
Convolutional Neural Networks (CNNs): CNNs are often used in AI denoising. They apply convolutional filters to process local image features, such as edges and textures, while removing noise.
Autoencoders: These are neural networks that learn to compress images into a lower-dimensional representation (encoding) and then reconstruct them back to their original form (decoding), filtering out noise in the process.
UNet Architecture: A commonly used architecture in image denoising that uses an encoder-decoder structure with “skip connections” to help preserve fine details during the denoising process.
Generative Adversarial Networks (GANs): GANs involve two networks—a generator and a discriminator. The generator tries to produce clean images from noisy ones, while the discriminator learns to distinguish between real clean images and those generated by the model. Over time, this adversarial process helps the generator improve its ability to denoise images.

Some of the Deep Learning Denoising Techniques include:
Denoising Autoencoders (DAEs): These networks are trained to reconstruct clean images from noisy ones by learning compressed representations of the data, which inherently filters out noise.
Blind-Spot Networks (BSNs): These networks are designed to ignore the pixel being predicted, making them effective in reducing bias during denoising. They focus on the neighboring pixels to predict the clean value for the noisy pixel.
Non-local Neural Networks: This method goes beyond the immediate neighborhood of a pixel and uses information from non-local regions of the image to denoise, much like the traditional Non-Local Means algorithm but with learned filters.

Once trained, an AI model can generalize to denoise images with different noise levels and types without requiring manual parameter adjustment. An example process of AI Denoising includes the following operations: a noisy image is passed through multiple convolutional layers, each layer extracts features like edges and patterns, the network gradually refines the image as it progresses through layers, removing noise while keeping details, and the output is a noise-free, clean version of the image.

Although some examples are described herein with reference to AI denoising, the same principles may be used with any other denoise algorithm. By using denoising, it is possible to obtain nighttime images with good quality for event detection without having to use infrared light.

The chart 800 shows the power consumption at different times of the day (e.g., daytime versus nighttime) by the digital camera (with and without infrared light on) and the power consumption by the AI denoiser.

The chart 800 shows two scenarios for power consumption. The first scenario is for line 804, which shows power consumption when using the digital camera and turning on the infrared light at night to improve image quality. Thus, the power consumption goes up at night with the infrared light on.

The second scenario is for line 802, which shows power consumption when the digital camera is on during the day and uses denoising at night without powering the infrared light. Thus, at night, the power consumption goes up by the amount of power used to perform AI denoising. The power used for AI denoising is typically much less power than the power used by the infrared light, resulting in power savings when using AI denoising. As a result, the power level during nighttime with denoising is lower than that of using the infrared light.

In some examples, when an event is detected, the infrared light may be turned on to improve visibility and image quality at the time when the event is taking place, such as when intruders enter a parking lot at night.

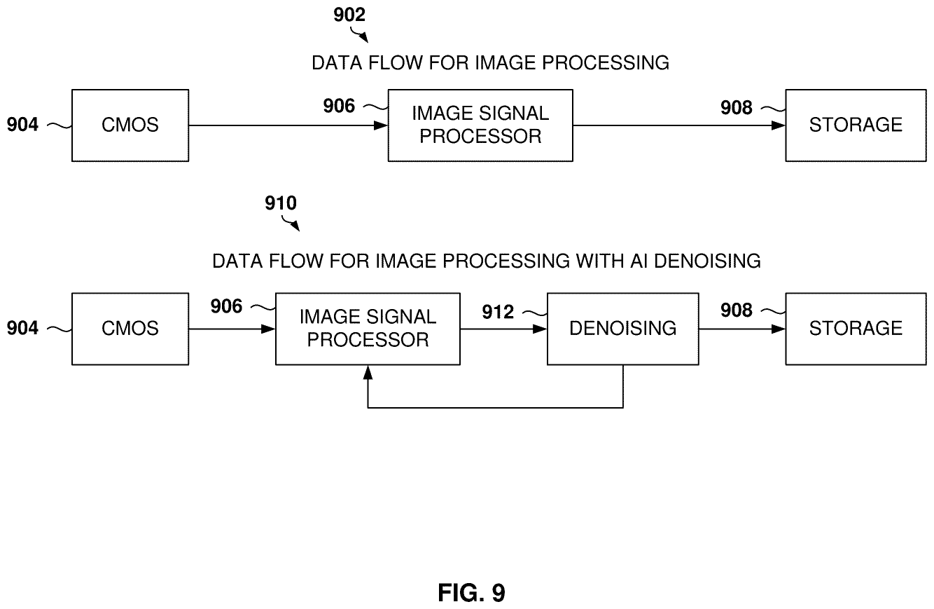

FIG. 9 shows the processing of images with and without denoising, according to some examples. The first process 902 shows the data flow for image processing and begins with a Complementary Metal-Oxide-Semiconductor (CMOS 904) that captures light and converts the light into electronic signals. These signals are then transmitted to an Image Signal Processor (ISP 906).

The ISP 906 performs standard image processing tasks such as auto-exposure, auto-gain, and white balance adjustments. Once processed, the image data is sent to storage 908 for recording and storage.

The second process 910 shows the data flow for image processing with AI denoising, and it also starts with the CMOS 904 capturing light and converting the light into electronic signals. These signals are then processed by the ISP 906, similar to the first process 902.

Before reaching storage 908, the data undergoes an additional step of denoising through a denoising 912 component. The denoising 912 component utilizes AI technology to enhance image quality by reducing noise, particularly in low-light conditions.

In some examples, a feedback loop, after denoising 912 and back to the ISP 906, is implemented to reintegrate certain elements and thereby enable enhanced manipulation of CMOS parameters and related components. The introduction of this feedback loop results in the generation of a higher-quality image.

This process improves the signal-to-noise ratio, allowing for clearer images without the need for infrared illumination. The enhanced image data is then stored in storage 908.

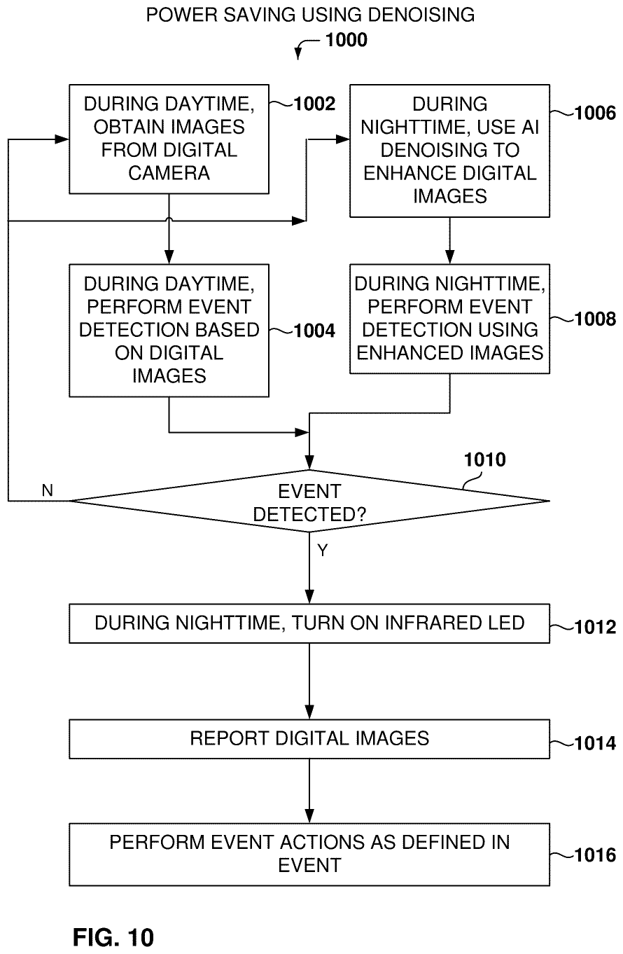

FIG. 10 is a flowchart of a method 1000 for reducing power consumption using denoising of a digital image, according to some examples. While the various operations in this flowchart are presented and described sequentially, one of ordinary skill will appreciate that some or all of the operations may be executed in a different order, be combined or omitted, or be executed in parallel.

The method 1000 includes two branches for daytime processing (operations 1002 and 1004) and nighttime (operations 1006 and 1008). At operation 1002, images are obtained from a digital camera during the daytime. This operation involves capturing visual data under natural lighting conditions, which typically requires less power consumption.

From operation 1002, the method flows to operation 1004 for performing event detection based on the digital images obtained during the daytime. This operation involves analyzing, by the one or more AI agents, the captured images to identify any predefined events or activities.

At operation 1006, during nighttime, the method uses AI denoising to enhance the digital images. This operation involves applying AI-based algorithms to improve image quality in low-light conditions, thereby reducing the need for infrared illumination and optimizing power usage.

From operation 1006, the method flows to operation 1008 for performing event detection using the enhanced images during nighttime. This operation involves analyzing the denoised images to detect events, similar to the process during daytime but with enhanced image data.

From operations 1004 and 1008, the method 1000 flows to operation 1010. At operation 1010, the AI agent determines whether an event has been detected. This decision-making process evaluates the results from operations 1004 and 1008 to ascertain the presence of any events.

If an event is detected, the method 1000 flows to operation 1012, and if no event is detected, the method 1000 flows to operation 1002 or 1006, depending on the time of day. At operation 1012, the infrared LED is turned on if it is nighttime. This operation provides additional illumination to capture clearer images of the detected event.

From operation 1012, the method flows to operation 1014 for reporting digital images. This operation involves transmitting the captured images to a designated server or storage system for further analysis or record-keeping.

From operation 1014, the method flows to operation 1016, where event actions are performed as defined in the agent configuration. This operation involves executing predefined responses or actions based on the detected event, such as sending notifications or activating alarms.

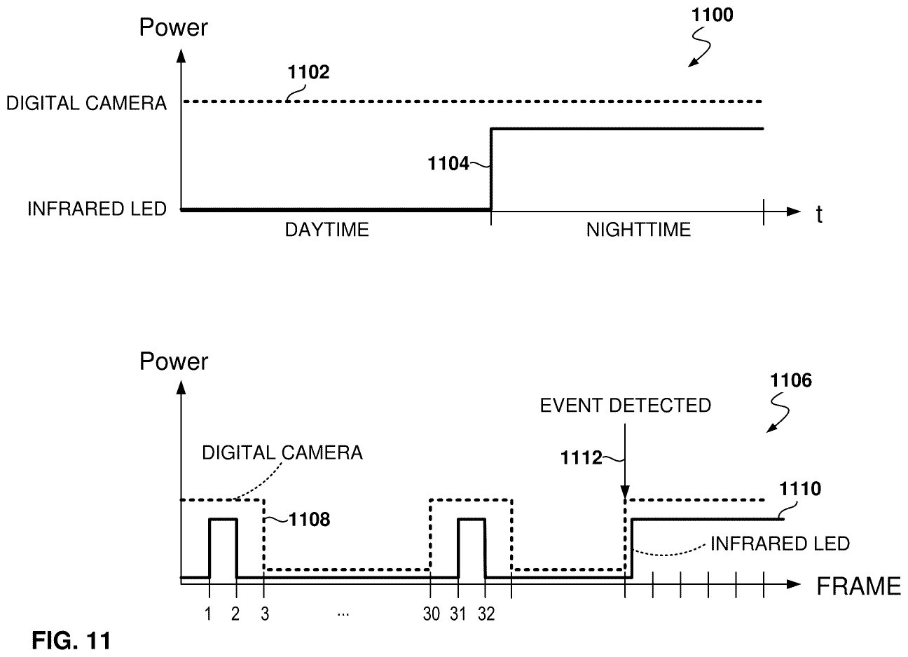

FIG. 11 includes charts showing the power consumption when using the infrared LED, according to some examples. An alternative method to conserve power involves employing distinct modes of operation. These modes can be divided into a detection phase and an image quality phase.

Typically, security cameras maintain their infrared LED illumination at full intensity throughout the night. Implementing a strategy such as duty cycling the infrared LED can save power. For instance, one mode of operation is set up to use a reduced frame rate for capturing images (e.g., one frame per second) during nighttime. In contrast, cameras generally operate at frame rates of either 30 frames per second or 15 frames per second.

The solution includes synchronizing the taking of images with the time when the infrared light is powered on. A snapshot is taken, during which the infrared LED is activated for approximately 33.3 milliseconds. This results in a high-quality image; however, only a single frame is captured. Subsequently, a pause of approximately one second occurs before capturing the next frame. The captured frames are then fed into an artificial intelligence model for further processing.

By using infrared light for a small percentage of time, significant savings may be achieved in the power used for infrared lighting. When an event of interest is detected (e.g., a person present, an animal present, a vehicle present), then the mode of the camera is changed to operate with the infrared light on constantly to get more details on the event.

The first chart 1100 depicts a typical power usage over time, distinguishing between daytime and nighttime operations. The second chart 1106 provides a detailed view of nighttime power consumption using intermittent power for the infrared light and highlights the behavior of the system when an event is detected.

In the first chart 1100, the digital camera power 1102 remains constant during daytime and daytime, indicating stable power usage without additional enhancements. During nighttime, the infrared LED power 1104 increases, reflecting the activation of infrared LEDs used to improve visibility in low-light conditions. This results in a higher power draw compared to daytime operations.

The second chart 1106 illustrates power consumption on a per-frame basis, showing periodic powering of the infrared light. The infrared LED power 1110 is duty-cycled, meaning the infrared LED power 1110 is activated for specific frames to conserve energy, e.g., once every 30 frames, but other duty cycles may be used.

The digital camera power 1108 shows periodic spikes corresponding to individual frames around the time the infrared light is on. In some examples, the digital camera takes a frame before the infrared cycle, a frame during, and a frame after. Other examples may use a single image coincidentally to the time the infrared light is on or take additional images before or after.

The result is that the power consumption is a fraction of the power used if the infrared light is always on, e.g., 1/30^{th} of the power.

When an event 1112 is detected, the infrared is powered on constantly, and the camera records at the regular frame rate. This way, additional details of the event may be collected with better or additional images. The power usage goes up after detection as a result.

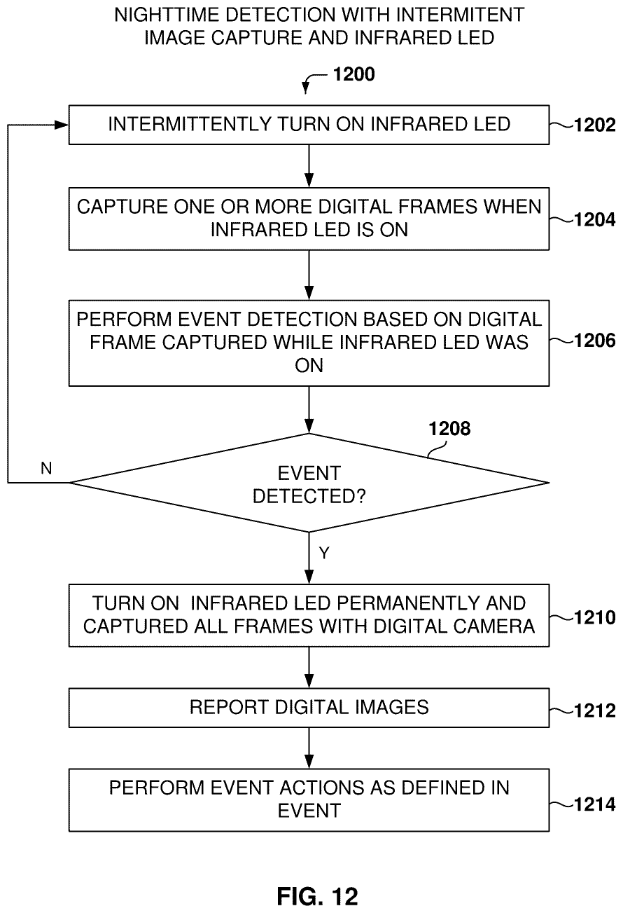

FIG. 12 is a flowchart of a method 1200 for nighttime event detection with intermittent image capture and the use of the infrared LED, according to some examples. While the various operations in this flowchart are presented and described sequentially, one of ordinary skill will appreciate that some or all of the operations may be executed in a different order, be combined or omitted, or be executed in parallel.

At operation 1202, the method begins with intermittently turning on the infrared LED. This operation involves activating the infrared LED at specific intervals to conserve power while still providing illumination for image capture.

From operation 1202, the method flows to operation 1204 for capturing one or more digital frames when the infrared light is on. This operation ensures that the digital camera captures images during the brief periods when the infrared light is active, optimizing power usage.

From operation 1204, the method flows to operation 1206 for performing event detection based on the digital frame captured while the infrared light was on. This operation involves analyzing the captured frames to identify any predefined events or activities using image processing techniques.

At operation 1208, the AI agent determines whether an event has been detected. If an event is detected, the method flows to operation 1210 and operation 1202 if the event is not detected.

At operation 1210, the infrared light is turned on permanently, and all frames are captured with the digital camera. This operation provides continuous illumination and image capture to document the detected event.

From operation 1210, the method flows to operation 1212 for reporting digital images. This operation is optional and involves transmitting the captured images to a designated server or storage system for further analysis or record-keeping.

From operation 1212, the method flows to operation 1214, where event actions are performed as defined in the event. This operation involves executing predefined responses or actions based on the detected event, such as sending notifications or activating alarms.

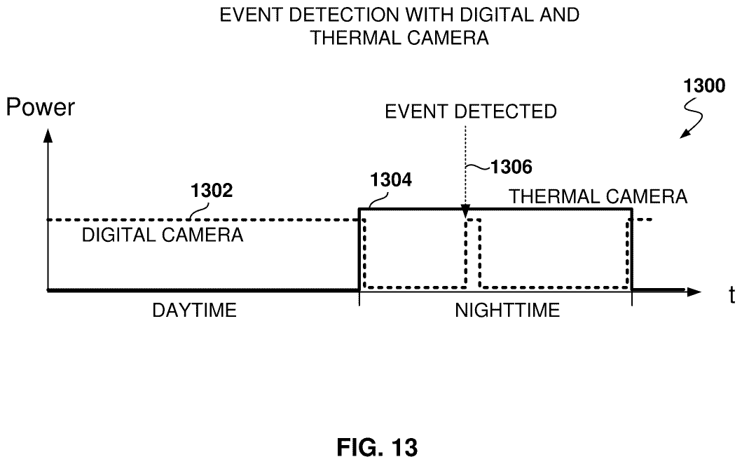

FIG. 13 is a chart showing event detection using a thermal camera, according to some examples. Another solution for saving power includes using thermal cameras for detection during nighttime. Typically, a thermal camera utilizes less power than a camera with the infrared light on.

The solution involves utilizing a low-power thermal sensor to detect the heat signature emitted by a person, a vehicle, or anything else with a heat signature different from the background.

In some examples, the digital camera is used for daytime detection, and the thermal camera is used for nighttime detection. The thermal sensor serves as the initial detection mechanism, subsequently activating the primary optical vision system. This method differs from capturing a single snapshot, as it employs the thermal sensor primarily for detection purposes before engaging the visible spectrum component.

If an event is detected at night, the digital camera may be turned on, including the use of infrared light as an option. In some examples, the thermal detection is conducted using monochrome images as opposed to color images, yet the process remains the same. The model is trained to detect objects using thermal images. It has been noted that thermal detection can identify vehicles, humans, and animals.

The chart 1300 illustrates the power usage pattern of a system employing both a digital camera and a thermal camera for event detection. The chart 1300 provides insights into how these components operate during different times of the day, specifically daytime and nighttime.

During the daytime, the digital camera operates at a consistent power level, as indicated by the stable line 1302. This reflects the camera's ability to function effectively under natural lighting conditions without additional power requirements.

As the system transitions to nighttime, the chart highlights a shift in power usage. The thermal camera becomes active, as shown by the power level 1304 associated with the thermal camera. This activation is necessary for maintaining surveillance capabilities in low-light conditions using the thermal camera.

The chart also marks an event 1306 detected, indicating a point in time when the system identifies an event requiring attention. This detection triggers the digital camera to be turned on to enhance the system's ability to capture and analyze the event.

The integration of both digital and thermal cameras allows the system to optimize power consumption while maintaining effective surveillance across varying lighting conditions.

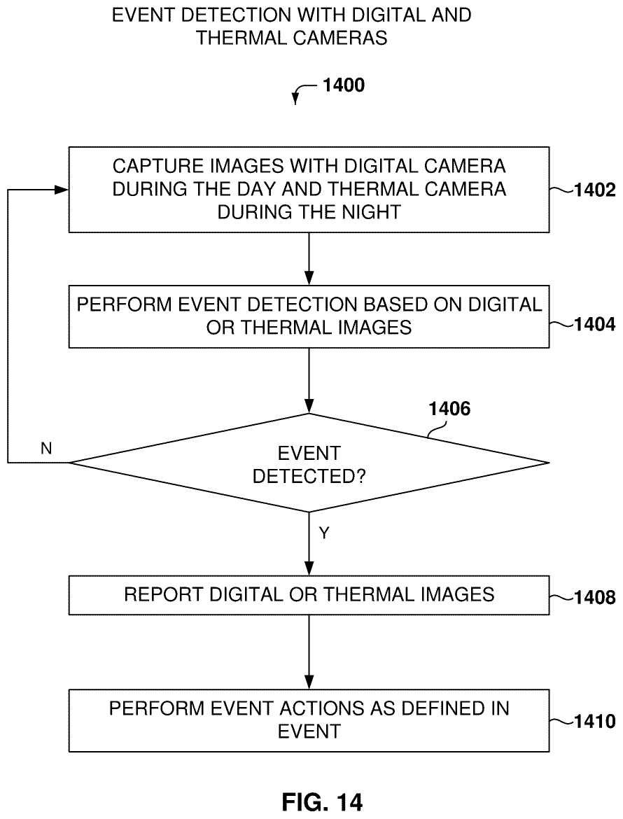

FIG. 14 is a flowchart of a method 1400 for event detection using digital and thermal cameras, according to some examples. While the various operations in this flowchart are presented and described sequentially, one of ordinary skill will appreciate that some or all of the operations may be executed in a different order, be combined or omitted, or be executed in parallel.

At operation 1402, the method 1400 involves capturing images using the digital camera during the day and the thermal camera during the night.

From operation 1402, the method 1400 flows to operation 1404 for performing event detection based on the digital or thermal images. This operation involves analyzing the captured images to identify any predefined events or activities using image processing techniques. The system processes the images to detect events that match specific triggers set for event detection.

At operation 1406, the method 1400 determines whether an event has been detected. This decision-making process evaluates the results from operation 1404 to ascertain the presence of any events. If no event is detected, the method loops back to operation 1402 to continue capturing images. If an event is detected, the method 1400 flows to operation 1408, where the digital or thermal images are reported. This is an optional operation and involves transmitting the captured images to a designated server or storage system for further analysis or record-keeping, ensuring that the detected event is documented.

From operation 1408, the method 1400 flows to operation 1410, where event actions are performed as defined in the event. This operation involves executing predefined responses or actions based on the detected event, such as sending notifications or activating alarms.

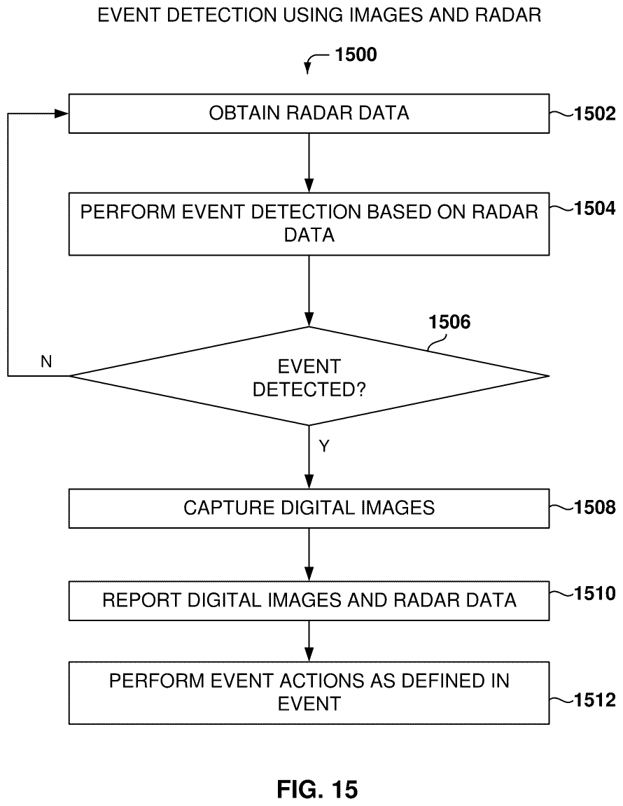

FIG. 15 is a flowchart of a method 1500 for event detection using digital images and RAdio Detection And Ranging (RADAR), according to some examples. While the various operations in this flowchart are presented and described sequentially, one of ordinary skill will appreciate that some or all of the operations may be executed in a different order, be combined or omitted, or be executed in parallel.

Radar technology is employed for object detection in various applications. One benefit of utilizing radar in such systems is the possibility of achieving an extended monitoring range. For instance, when the objective is to detect a human or vehicle at distances exceeding 100 meters, achieving this with vision systems presents challenges due to limitations in sensor resolution, lighting conditions, and the requirement for substantial zoom capabilities. In contrast, radar technology typically offers enhanced fidelity.

Additionally, radar provides benefits in terms of reduced sensitivity to environmental conditions such as rain and snow, which pose challenges for vision systems. Consequently, radar may prove more effective for detection tasks at considerable distances.

Further, both digital camera and radar may be used together, such as by using radar for long-distance detection and images for detection on shorter distances. Further, the image detection may be turned off during normal operations, and radar may be used for detection. Once an event is detected or suspected, based on the radar data, the system may start capturing digital images based on the radar information. For example, the radar information may determine the location where the object of interest is located, and the digital camera may zoom in on that location to get visual information.

Operation 1502 involves collecting data from radar sensors to monitor an area for potential events. The radar data provides information about the presence and movement of objects within the monitored area.

From operation 1502, the method flows to operation 1504 for performing event detection based on the radar data. This operation involves analyzing the radar data to identify any predefined events or activities. The analysis may include detecting motion patterns or changes in the environment that match specific criteria for event detection.

At operation 1506, the method determines whether an event has been detected. This decision-making process evaluates the results from operation 1504 to ascertain the occurrence of any event. If no event is detected, the method loops back to operation 1502 to continue obtaining radar data.

If an event is detected, the method flows to operation 1508, where digital images are captured. This operation involves activating cameras to capture visual data of the detected event, providing additional context and verification of the radar findings.

From operation 1508, the method flows to operation 1510 for reporting digital images and radar data. This optional operation involves transmitting the captured images and radar data to a designated server or storage system for further analysis or record-keeping, ensuring that the detected event is documented.

From operation 1510, the method flows to operation 1512, where event actions are performed as defined in the event. This operation involves executing predefined responses or actions based on the detected event, such as sending notifications or activating alarms.

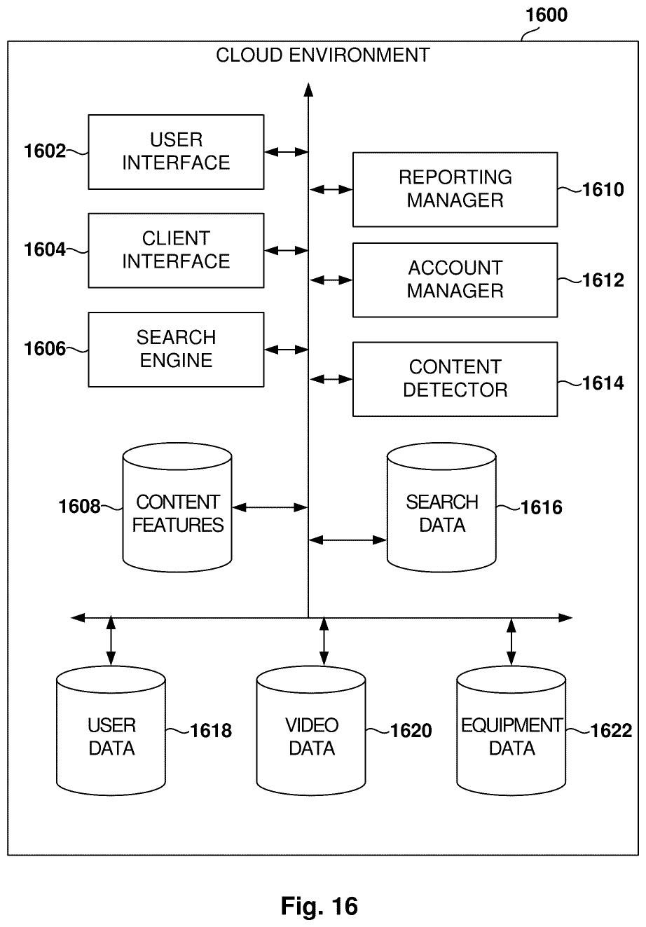

FIG. 16 illustrates a cloud environment 1600 for implementing examples. The cloud environment 1600 may include one or more servers and one or more databases that may be distributed across one or more storage devices.

The cloud environment 1600 includes a user interface 1602, a client interface 1604, a search engine 1606, a reporting manager 1610, an account manager 1612, a content detector 1614, and several databases. The databases include content features 1608, search data 1616, user data 1618, video data 1620, and equipment data 1622.

The user interface 1602 facilitates interaction between users and the cloud system by providing user interfaces, as the UIs described above with reference to FIGS. 1, 4, 5, and 7. The client interface 1604 enables communication with external client systems, such as via APIs.

The search engine 1606 processes queries and retrieves relevant information. The reporting manager 1610 generates reports based on data analysis. The account manager 1612 handles user accounts and associated activities. The content detector 1614 identifies and categorizes content within the surveillance images.

The content features 1608 database stores information about detected content, including the metadata captured for the content. The search data 1616 database stores information related to user search activities. The user data 1618 database contains information about the users interacting with the cloud environment 1600.

Further, the video data 1620 databases store video content received from surveillance cameras. The equipment data 1622 database holds information about hardware and other equipment used in the system, such as cameras (e.g., make, model, installation date, location) and IVRs (e.g., make, model, installation date, location, encryption keys).

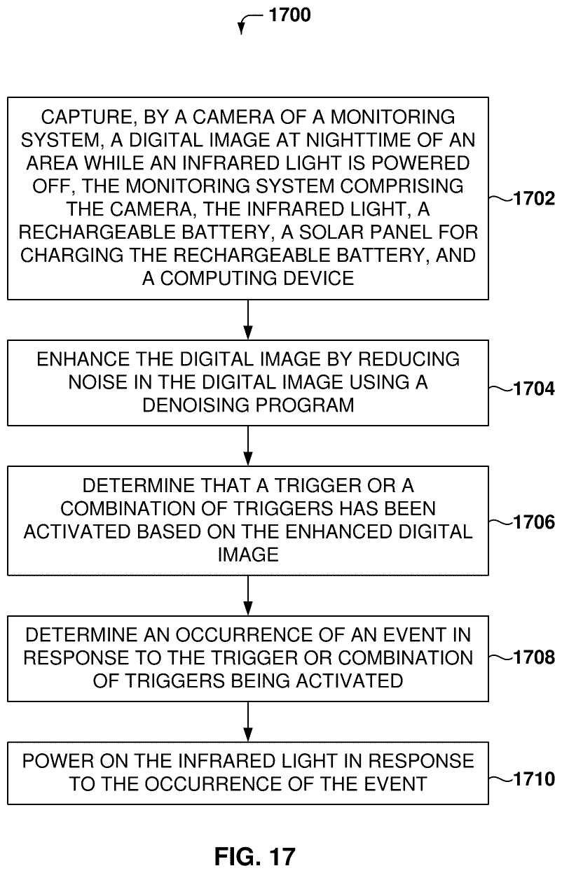

FIG. 17 is a flowchart of a method 1700 for power management in a remote security monitoring system, according to some examples. While the various operations in this flowchart are presented and described sequentially, one of ordinary skill will appreciate that some or all of the operations may be executed in a different order, be combined or omitted, or be executed in parallel.

At operation 1702, the method begins with capturing, by a camera of a monitoring system, a digital image at nighttime of an area while an infrared light is powered off. The monitoring system comprises the camera, the infrared light, a rechargeable battery, a solar panel for charging the rechargeable battery, and a computing device. This operation involves utilizing the camera to obtain visual data under low-light conditions without the aid of infrared illumination, thereby conserving power.

From operation 1702, the method flows to operation 1704 for enhancing the digital image by reducing noise in the digital image using a denoising program. In some examples, an AI denoising model may be used, but other examples may use other denoising algorithms.

From operation 1704, the method flows to operation 1706 for determining that a trigger or a combination of triggers has been activated based on the enhanced digital image. This operation involves analyzing the enhanced image to identify specific conditions or events that meet predefined criteria, utilizing object detection and predefined triggers.

From operation 1706, the method flows to operation 1708 for determining an occurrence of an event in response to the trigger or combination of triggers being activated. This operation involves confirming the presence of an event based on the activated triggers, which may include detecting movement, object presence, or other predefined scenarios.

From operation 1708, the method flows to operation 1710 for powering on the infrared light in response to the occurrence of the event. This operation provides additional illumination to capture clearer images of the detected event, ensuring comprehensive documentation and analysis.

In view of the disclosure above, various examples are set forth below. It should be noted that one or more features of an example, taken in isolation or combination, should be considered within the disclosure of this application.

Example 1. A computer-implemented method comprising: capturing, by a camera of a monitoring system, a digital image at nighttime of an area while an infrared light is powered off, the monitoring system comprising the camera, the infrared light, a rechargeable battery, a solar panel for charging the rechargeable battery, and a computing device; enhancing the digital image by reducing noise in the digital image using a denoising program; determining that a trigger or a combination of triggers has been activated based on the enhanced digital image; determining an occurrence of an event in response to the trigger or combination of triggers being activated; and powering on the infrared light in response to the occurrence of the event.

Example 2. The method of Example 1, further comprising: capturing additional digital images while the infrared light is powered on; and sending the digital image and the additional digital images to a server.

Example 3. The method of any one or more of Examples 1-2, further comprising: automatically performing one or more actions in response to the occurrence of the event.

Example 4. The method of any one or more of Examples 1-3, further comprising: causing presentation of a user interface (UI) comprising options for defining the trigger or the combination of triggers, and the one or more actions to be performed in response to the occurrence of the event.

Example 5. The method of any one or more of Examples 1-4, wherein the one or more actions comprise send notification of the occurrence of the event and turning on floodlights.

Example 6. The method of any one or more of Examples 1-5, wherein the one or more actions comprise playing a message on a loudspeaker and activating a sound alarm by the monitoring system.

Example 7. The method of any one or more of Examples 1-6, wherein determining that a trigger or a combination of triggers has been activated comprises: detecting a location of objects within the enhanced digital image; calculating a relationship between the locations of the objects; and determining that the trigger or combination of triggers has been activated based on the relationship between the locations of the objects.

Example 8. The method of any one or more of Examples 1-7, wherein the relationship between the locations of two detected objects is selected from a group comprising overlapping, directional relationship of one object with reference to another object, and distance between objects.

Example 9. The method of any one or more of Examples 1-8, further comprising: periodically turning on the infrared light; and capturing another digital image while the infrared light is on.

Example 10. The method of any one or more of Examples 1-9, further comprising: utilizing radar to monitor an area around the monitoring system; and detecting an object based on radar data; and adjusting camera settings to capture video of the detected object. distance.

Example 11. A monitoring system comprising: an infrared light; a camera configured to capture a digital image at nighttime of an area while the infrared light is powered off; a rechargeable battery; a solar panel for charging the rechargeable battery; and a computing device comprising a memory with instructions and one or more computer processors, wherein the instructions, when executed by the one or more computer processors, causing the computing device to perform operations comprising: enhancing the digital image by reducing noise in the digital image using a denoising program; determining that a trigger or a combination of triggers has been activated based on the enhanced digital image; determining an occurrence of an event in response to the trigger or combination of triggers being activated; and powering on the infrared light in response to the occurrence of the event.

Example 12. The monitoring system of Example 11, wherein the instructions further cause the one or more computer processors to perform operations comprising: capturing additional digital images while the infrared light is powered on; and sending the digital image and the additional digital images to a server.

Example 13. The monitoring system of any one or more of Examples 11-12, wherein the instructions further cause the one or more computer processors to perform operations comprising: automatically performing one or more actions in response to the occurrence of the event.

Example 14. The monitoring system of any one or more of Examples 11-13, wherein the instructions further cause the one or more computer processors to perform operations comprising: causing presentation of a user interface (UI) comprising options for defining the trigger or the combination of triggers, and the one or more actions to be performed in response to the occurrence of the event.

Example 15. The monitoring system of any one or more of Examples 11-14, wherein the one or more actions comprise send notification of the occurrence of the event, turning on floodlights, playing a message on a loudspeaker, and activating a sound alarm by the monitoring system.

Example 16. A non-transitory machine-readable storage medium including instructions that, when executed by a machine, cause the machine to perform operations comprising: capturing, by a camera of a monitoring system, a digital image at nighttime of an area while an infrared light is powered off, the monitoring system comprising the camera, the infrared light, a rechargeable battery, a solar panel for charging the rechargeable battery, and a computing device; enhancing the digital image by reducing noise in the digital image using a denoising program; determining that a trigger or a combination of triggers has been activated based on the enhanced digital image; determining an occurrence of an event in response to the trigger or combination of triggers being activated; and powering on the infrared light in response to the occurrence of the event.

Example 17. The non-transitory machine-readable storage medium of Example 16, wherein the machine further performs operations comprising:

capturing additional digital images while the infrared light is powered on; and

sending the digital image and the additional digital images to a server.

Example 18. The non-transitory machine-readable storage medium of any one or more of Examples 16-17, wherein the machine further performs operations comprising: automatically performing one or more actions in response to the occurrence of the event.

Example 19. The non-transitory machine-readable storage medium of any one or more of Examples 16-18, wherein the machine further performs operations comprising: causing presentation of a user interface (UI) comprising options for defining the trigger or the combination of triggers, and the one or more actions to be performed in response to the occurrence of the event.

Example 20. The non-transitory machine-readable storage medium of any one or more of Examples 16-19, wherein the one or more actions comprise send notification of the occurrence of the event, turning on floodlights, playing a message on a loudspeaker, and activating a sound alarm by the monitoring system.

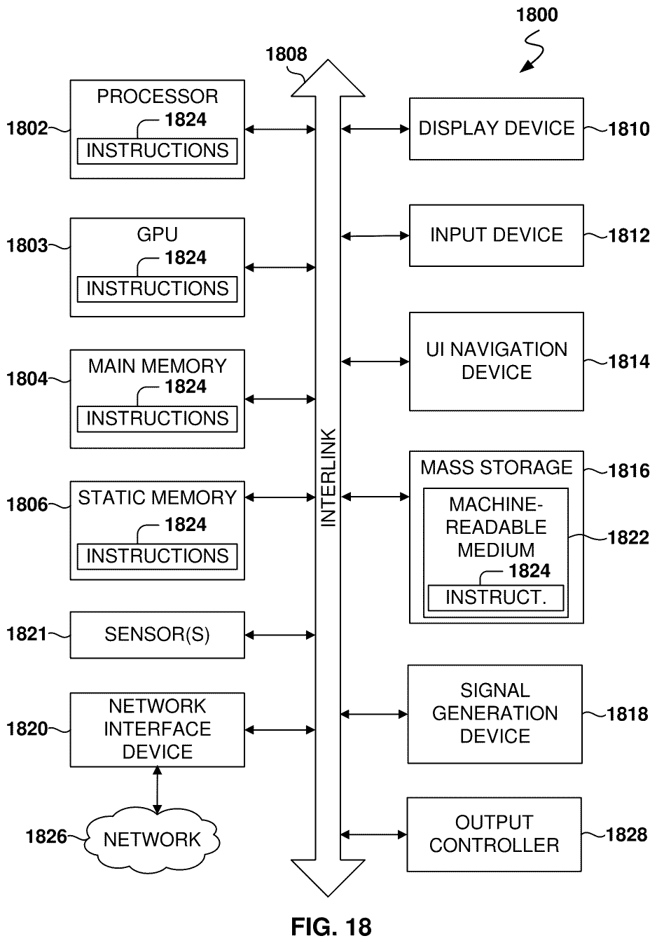

FIG. 18 is a block diagram illustrating an example of a machine 1800 upon or by which one or more example process examples described herein may be implemented or controlled. In alternative examples, the machine 1800 may operate as a standalone device or be connected (e.g., networked) to other machines. In a networked deployment, the machine 1800 may operate in the capacity of a server machine, a client machine, or both in server-client network environments. In an example, the machine 1800 may act as a peer machine in a peer-to-peer (P2P) (or other distributed) network environment. Further, while only a single machine 1800 is illustrated, the term “machine” shall also be taken to include any collection of machines that individually or jointly execute a set (or multiple sets) of instructions to perform any one or more of the methodologies discussed herein, such as via cloud computing, software as a service (Saas), or other computer cluster configurations.

Examples, as described herein, may include, or may operate by, logic, various components, or mechanisms. Circuitry is a collection of circuits implemented in tangible entities, including hardware (e.g., simple circuits, gates, logic). Circuitry membership may be flexible over time and underlying hardware variability. Circuitries include members that may, alone or in combination, perform specified operations when operating. In an example, the hardware of the circuitry may be immutably designed to carry out a specific operation (e.g., hardwired). In an example, the hardware of the circuitry may include variably connected physical components (e.g., execution units, transistors, simple circuits), including a computer-readable medium physically modified (e.g., magnetically, electrically, by moveable placement of invariant massed particles) to encode instructions of the specific operation. In connecting the physical components, the underlying electrical properties of a hardware constituent are changed (for example, from an insulator to a conductor or vice versa). The instructions enable embedded hardware (e.g., the execution units or a loading mechanism) to create members of the circuitry in hardware via the variable connections to carry out portions of the specific operation when in operation. Accordingly, the computer-readable medium is communicatively coupled to the other circuitry components when the device operates. In an example, any of the physical components may be used in more than one member of more than one circuitry. For example, under operation, execution units may be used in a first circuit of a first circuitry at one point in time and reused by a second circuit in the first circuitry or by a third circuit in a second circuitry at a different time.

The machine 1800 (e.g., computer system) may include a hardware processor 1802 (e.g., a central processing unit (CPU), a hardware processor core, or any combination thereof), an AI accelerator, a graphics processing unit (GPU 1803), a main memory 1804, and a static memory 1806, some or all of which may communicate with each other via an interlink 1808 (e.g., bus). The machine 1800 may further include a display device 1810, an alphanumeric input device 1812 (e.g., a keyboard), and a user interface (UI) navigation device 1814 (e.g., a mouse). In an example, the display device 1810, alphanumeric input device 1812, and UI navigation device 1814 may be a touch screen display. The machine 1800 may additionally include a mass storage device 1816 (e.g., drive unit), a signal generation device 1818 (e.g., a speaker), a network interface device 1820, and one or more sensors 1821, such as a Global Positioning System (GPS) sensor, compass, accelerometer, or another sensor. The machine 1800 may include an output controller 1828, such as a serial (e.g., universal serial bus (USB)), parallel, or other wired or wireless (e.g., infrared (IR), near field communication (NFC)) connection to communicate with or control one or more peripheral devices (e.g., a printer, card reader).

The processor 1802 refers to any one or more circuits or virtual circuits (e.g., a physical circuit emulated by logic executing on an actual processor) that manipulates data values according to control signals (e.g., commands, opcodes, machine code, control words, macroinstructions, etc.) and which produces corresponding output signals that are applied to operate a machine. A processor 1802 may, for example, include at least one of a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), a Tensor Processing Unit (TPU), a Neural Processing Unit (NPU), a Vision Processing Unit (VPU), a Machine Learning Accelerator, an Artificial Intelligence Accelerator, an Application Specific Integrated Circuit (ASIC), a Field Programmable Gate Array (FPGA), a Radio-Frequency Integrated Circuit (RFIC), a Neuromorphic Processor, a Quantum Processor, or any combination thereof.

The processor 1802 may further be a multi-core processor having two or more independent processors (sometimes referred to as “cores”) that may execute instructions contemporaneously. Multi-core processors contain multiple computational cores on a single integrated circuit die, each of which can independently execute program instructions in parallel. Parallel processing on multi-core processors may be implemented via architectures like superscalar, VLIW, vector processing, or SIMD that allow each core to run separate instruction streams concurrently. The processor 1802 may be emulated in software, running on a physical processor, as a virtual processor or virtual circuit. The virtual processor may behave like an independent processor but is implemented in software rather than hardware.

The mass storage device 1816 may include a machine-readable medium 1822 on which one or more sets of data structures or instructions 1824 (e.g., software) embodying or utilized by any of the techniques or functions described herein. The instructions 1824 may also reside, completely or at least partially, within the main memory 1804, within the static memory 1806, within the hardware processor 1802, or the GPU 1803 during execution thereof by the machine 1800. For example, one or any combination of the hardware processor 1802, the GPU 1803, the main memory 1804, the static memory 1806, or the mass storage device 1816 may constitute machine-readable media.

While the machine-readable medium 1822 is illustrated as a single medium, the term “machine-readable medium” may include a single medium or multiple media (e.g., a centralized or distributed database and associated caches and servers) configured to store one or more instructions 1824.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The term “machine-readable medium” may include any medium that is capable of storing, encoding, or carrying instructions 1824 for execution by the machine 1800 and that causes the machine 1800 to perform any one or more of the techniques of the present disclosure or that is capable of storing, encoding, or carrying data structures used by or associated with such instructions 1824. Non-limiting machine-readable medium examples may include solid-state memories and optical and magnetic media. For example, a massed machine-readable medium comprises a machine-readable medium 1822 with a plurality of particles having invariant (e.g., rest) mass. Accordingly, massed machine-readable media are not transitory propagating signals. Specific examples of massed machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage medium,” “computer-storage medium,” and “device-storage medium” specifically exclude carrier waves, modulated data signals, and other such media.

The instructions 1824 may be transmitted or received over a communications network 1826 using a transmission medium via the network interface device 1820. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1824 for execution by the machine 1800, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented separately. These and other variations, modifications, additions, and improvements fall within the scope of the subject matter herein.

The examples illustrated herein are described in sufficient detail to enable those skilled in the art to practice the teachings disclosed. Other examples may be used and derived therefrom, such that structural and logical substitutions and changes may be made without departing from the scope of this disclosure. The Detailed Description, therefore, is not to be taken in a limiting sense, and the scope of various examples is defined only by the appended claims, along with the full range of equivalents to which such claims are entitled.

Additionally, as used in this disclosure, phrases of the form “at least one of an A, a B, or a C,” “at least one of A, B, and C,” and the like should be interpreted to select at least one from the group that comprises “A, B, and C.” Unless explicitly stated otherwise in connection with a particular instance, in this disclosure, this manner of phrasing does not mean “at least one of A, at least one of B, and at least one of C.” As used in this disclosure, the example “at least one of an A, a B, or a C” would cover any of the following selections: {A}, {B}, {C}, {A, B}, {A, C}, {B, C}, and {A, B, C}.

Moreover, plural instances may be provided for resources, operations, or structures described herein as a single instance. Additionally, boundaries between various resources, operations, modules, engines, and data stores are somewhat arbitrary, and particular operations are illustrated in the context of specific illustrative configurations. Other allocations of functionality are envisioned and may fall within the scope of various examples of the present disclosure. In general, structures and functionality are presented as separate resources in the example; configurations may be implemented as a combined structure or resource. Similarly, structures and functionality presented as a single resource may be implemented as separate resources. These and other variations, modifications, additions, and improvements fall within a scope of examples of the present disclosure as represented by the appended claims. Accordingly, the specification and drawings are to be regarded in an illustrative rather than a restrictive sense.

Some of the concepts used for the description of the solution are presented below.

An event is a specific occurrence of a predefined situation detected by the video surveillance system. For example, the event occurrence may be identified using heuristics or AI models and may involve the detection of object presence, object absence, object interactions, or relationships between objects. The occurrence of the event is detected based on a trigger or a combination of triggers.

A verified event is an event that has been verified automatically, e.g., using an automated AI transformer-based cognition system that watches the event and determines whether the event has been positively detected.

A trigger is a condition used to determine when an event has occurred. Many types of conditions may be used, such as conditions based on object attributes, relationships between the objects, timing of the objects, missing objects, etc. When the condition is satisfied, then the trigger is said to have been activated.

A trigger combination is a set of triggers that can be logically combined using logical operations to determine when an event has occurred.

An action includes a predefined response executed by the system upon detecting an event, such as sending notifications or triggering alarms.

An agent is a program that determines if a trigger, or a combination of triggers, is activated to determine that an event has occurred. The agent performs one or more actions when the trigger is activated. If an agent is based on a single trigger, the agent will determine that the associated event has occurred when the trigger is activated. If an agent is based on a trigger combination, the agent will determine that the event has occurred when the trigger combination is activated.

An event template is a pre-configured agent for detecting the occurrence of a specific type of event. The event template comprises one or more triggers and one or more actions.

A frame includes a single image captured by a camera, forming part of the continuous video data used for detecting objects and events.

An object includes an entity detected within video frames, such as people, vehicles, tools, or weapons, identified by attributes like identity, color, and position.

A denoising program is a software application used to enhance digital images by reducing noise, particularly in low-light conditions, to improve image quality.

A rechargeable battery is an energy storage device that powers the monitoring system, including the camera and infrared light, and is charged by a solar panel.

A solar panel is a device used to charge the rechargeable battery of a monitoring system, enabling autonomous operation without external power sources.

What is claimed is:

1. A computer-implemented method comprising:
capturing, by a camera of a monitoring system, a digital image at nighttime of an area while an infrared light is powered off, the monitoring system comprising the camera, the infrared light, a rechargeable battery, a solar panel for charging the rechargeable battery, and a computing device;
enhancing the digital image by reducing noise in the digital image using a denoising program;
determining that a trigger or a combination of triggers has been activated based on the enhanced digital image;
determining an occurrence of an event in response to the trigger or combination of triggers being activated; and
powering on the infrared light in response to the occurrence of the event.

2. The method as recited in claim 1, further comprising:
capturing additional digital images while the infrared light is powered on; and
sending the digital image and the additional digital images to a server.

3. The method as recited in claim 1, further comprising:
automatically performing one or more actions in response to the occurrence of the event.

4. The method as recited in claim 3, further comprising:
causing presentation of a user interface (UI) comprising options for defining the trigger or the combination of triggers and the one or more actions to be performed in response to the occurrence of the event.

5. The method as recited in claim 3, wherein the one or more actions comprise send notification of the occurrence of the event and turning on floodlights.

6. The method as recited in claim 3, wherein the one or more actions comprise playing a message on a loudspeaker and activating a sound alarm by the monitoring system.

7. The method as recited in claim 1, wherein determining that a trigger or a combination of triggers has been activated comprises:
detecting a location of objects within the enhanced digital image;
calculating a relationship between the locations of the objects; and
determining that the trigger or combination of triggers has been activated based on the relationship between the locations of the objects.

8. The method as recited in claim 1, wherein a relationship between locations of two detected objects is selected from a group comprising overlapping, directional relationship of one object with reference to another object, and distance between objects.

9. The method as recited in claim 1, further comprising:
periodically turning on the infrared light; and
capturing another digital image while the infrared light is on.

10. The method as recited in claim 1, further comprising:
utilizing radar to monitor an area around the monitoring system;
detecting an object based on radar data; and
adjusting camera settings to capture video of the detected object.

11. A monitoring system comprising:
an infrared light;
a camera configured to capture a digital image at nighttime of an area while the infrared light is powered off;
a rechargeable battery;
a solar panel for charging the rechargeable battery; and
a computing device comprising a memory with instructions and one or more computer processors, wherein the instructions, when executed by the one or more computer processors, causing the computing device to perform operations comprising:
enhancing the digital image by reducing noise in the digital image using a denoising program;
determining that a trigger or a combination of triggers has been activated based on the enhanced digital image;
determining an occurrence of an event in response to the trigger or combination of triggers being activated; and
powering on the infrared light in response to the occurrence of the event.

12. The monitoring system as recited in claim 11, wherein the instructions further cause the one or more computer processors to perform operations comprising:
capturing additional digital images while the infrared light is powered on; and
sending the digital image and the additional digital images to a server.

13. The monitoring system as recited in claim 11, wherein the instructions further cause the one or more computer processors to perform operations comprising:
automatically performing one or more actions in response to the occurrence of the event.

14. The monitoring system as recited in claim 13, wherein the instructions further cause the one or more computer processors to perform operations comprising:
causing presentation of a user interface (UI) comprising options for defining the trigger or the combination of triggers and the one or more actions to be performed in response to the occurrence of the event.

15. The monitoring system as recited in claim 13, wherein the one or more actions comprise send notification of the occurrence of the event, turning on floodlights, playing a message on a loudspeaker, and activating a sound alarm by the monitoring system.

16. A non-transitory machine-readable storage medium including instructions that, when executed by a machine, cause the machine to perform operations comprising:
capturing, by a camera of a monitoring system, a digital image at nighttime of an area while an infrared light is powered off, the monitoring system comprising the camera, the infrared light, a rechargeable battery, a solar panel for charging the rechargeable battery, and a computing device;
enhancing the digital image by reducing noise in the digital image using a denoising program;
determining that a trigger or a combination of triggers has been activated based on the enhanced digital image;
determining an occurrence of an event in response to the trigger or combination of triggers being activated; and
powering on the infrared light in response to the occurrence of the event.

17. The non-transitory machine-readable storage medium as recited in claim 16, wherein the machine further performs operations comprising:
capturing additional digital images while the infrared light is powered on; and
sending the digital image and the additional digital images to a server.

18. The non-transitory machine-readable storage medium as recited in claim 16, wherein the machine further performs operations comprising:
automatically performing one or more actions in response to the occurrence of the event.

19. The non-transitory machine-readable storage medium as recited in claim 18, wherein the machine further performs operations comprising:
causing presentation of a user interface (UI) comprising options for defining the trigger or the combination of triggers and the one or more actions to be performed in response to the occurrence of the event.

20. The non-transitory machine-readable storage medium as recited in claim 18, wherein the one or more actions comprise send notification of the occurrence of the event, turning on floodlights, playing a message on a loudspeaker, and activating a sound alarm by the monitoring system.
